(19) United States
(12) Patent Application Publication
(10) Pub. No.: US 2002/0079430 A1
(43) Pub. Date: Jun. 27, 2002

(54) Method and apparatus for mounting an optical component

(76) Inventor: David Rossi, San Francisco, CA (US)

Correspondence Address: KENYON & KENYON, ONE BROADWAY, NEW YORK, NY, 10004, US

(21) Appl. No.: 09/745,315

(22) Filed: Dec. 22, 2000

(51) Int. Cl. H01J 3/14

(52) U.S. Cl. 250/216

(57) ABSTRACT

A method and apparatus are provided for securing an optical component, such as a lens, into a receptacle hole. A spring ring is provided having a plurality of sections that exert pressure on the periphery of the optical component and the inside surface of the receptacle hole, thus holding the optical component in place.

### BACKGROUND OF THE INVENTION

The present invention relates to a method and apparatus for mounting an optical component such as mirrors, lenses, etc. in a photonic system. More particularly, the present invention pertains to the mounting of a cylindrical mirror, lens, etc. into a hole or recess provided in a holding apparatus or the like.

Laser (Light Amplification by Stimulated by Emission of Radiation) devices are well known in the art. These devices include semiconductor laser devices, which under the right circumstances will emit a coherent light in a limited frequency range. As part of the device, the light may be at least partially reflected between opposing mirrors. One of these mirrors may also serve as a lens to focus emitted light for a light-carrying medium (e.g., a fiber-optic cable).

In one application, this lens/mirror has a partially cylindrical shape and is properly positioned by first placing the lens/mirror into a receptacle hole of a washer. Securely fitting the lens/mirror into position in the washer can be very difficult, whether the lens/mirror is to be secured using a so-called interference fit or with an epoxy. First, exerting too much lateral pressure on the cylindrical sides of the lens/mirror could cause the piece to shatter. Second, pressing down on the top or bottom of the lens can damage the outside surface of the lens. Third, the size of the lens/mirror can be very small comparatively (e.g., 0.010 inches in height and 0.040 inches in diameter). Finally, when using an epoxy, there is the possibility that the epoxy will interfere with the reflectivity and/or focusing features of the lens/mirror (due to outgassing of the epoxy material).

In view of the above, an improved method and apparatus for mounting a mirror or lens that overcomes the problems addressed above is needed.

### SUMMARY OF THE INVENTION

According to an embodiment of the present invention, a spring ring is provided that provides lateral support for a optical component such as a mirror and/or lens when placed into a receptacle hole. In one embodiment, the spring ring includes a plurality of sections where the sections are adapted to be angled relative to each other so as to hold the optical component. The optical component may have any of a variety of shapes including a cylindrical shape and a spherical shape. The optical component may be inserted into a receptacle hole in a washer and the combined structure may be part of a photonic system.

### BRIEF DESCRIPTION OF THE DRAWINGS

FIGS. 1 a-b are schematic diagrams of a spring ring prior to being bent into its appropriate configuration according to an embodiment of the present invention.

FIG. 2 is a top view of the spring ring of FIGS. 1 a-b bent into is appropriate configuration prior to insertion into a receptacle hole.

FIG. 3 is a top view of the spring ring of FIGS. 1 and 2 used to secure a cylindrical lens in a receptacle hole according to an embodiment of the present invention.

FIGS. 4a-b are schematic diagrams of a spring ring constructed according to a second embodiment of the present invention.

FIG. 5 is a schematic diagram of a manufacturing system for placing a spring ring and lens into a receptacle hole in a washer according to a first embodiment of the present invention.

FIG. 6 is a side view of a ramming tool to be used with the manufacturing system of FIG. 5.

FIG. 7 is a cross-sectional view of the manufacturing system of FIG. 5.

FIG. 8 is a schematic diagram of a manufacturing system for placing a spring ring and lens into a receptacle hole in a washer according to a second embodiment of the present invention.

FIGS. 9a-g are schematic diagrams of the components of FIG. 8.

FIG. 10 is a cross-sectional diagram of a laser device incorporating a spring ring and lens combination according to an embodiment of the present invention.

### DETAILED DESCRIPTION

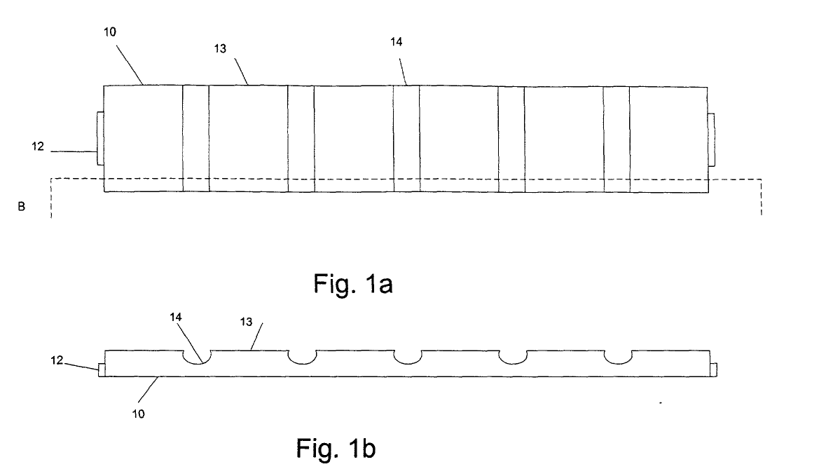

In a first embodiment of the present invention, a lens having a substantially cylindrical shape (for example with a 0.040 inch diameter and 0.030 inch height) is to be placed into a washer having a receptacle hole (for example with a 0.048 inch diameter and a 0.032 inch height). As used herein the term “lens” refers to an element that has focal properties and includes elements that have reflective and focal properties commonly used in or with laser devices. Referring to FIGS. 1a-b, a first embodiment of the present invention is shown. FIG. 1b is a cross-sectional view taken along line B in FIG. 1a. In this embodiment, a spring ring 10 is formed as a sheet of material having, for example, a length of 0.129 inches, a width of 0.032 inches, and a thickness of 0.003 inches. Each section 13 of the spring ring has, for example, a width of 0.0205 inches. In this embodiment, the spring ring 10 includes five notches 14 (e.g., semicircular cutouts) between each adjacent pair of sections 13. These dimensions are merely representative, and the invention is not limited to these specific dimensions. These notches can be made, for example, with a routing or sawing process or with other such processes known in the art including photolithographic etching. For mass production, tabs 12 are provided at each end of the spring ring so that multiple spring rings may be made from a sheet of material. Once a series of spring rings are made, they can be easily separated from one another at the tab. In this embodiment, the tab has, for example, a width of 0.014 inches, a length of 0.002 inches and a thickness of 0.0015 inches. As with the notches 14, the tabs 12 may be made with a routing or sawing process.

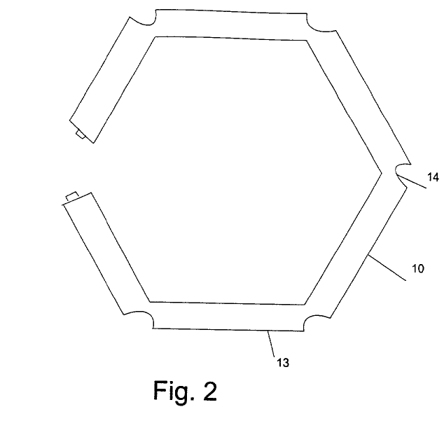

Referring to FIG. 2, the spring ring 10 in its bent position is shown. In this embodiment, the notches 14 facilitate the bending of the spring ring at the notch locations so that each section 13 will have an equal length and angular relationship. Rather than having the notches facing the outside of the spring ring, the spring ring may be bent in the opposite direction so that the notches are on the ring's inside. The spring ring can be made of a variety of materials such as the alloy sold under the trade name KOVAR (an alloy of iron, cobalt, and nickel), stainless steel, molybdenum, and others including plastic or polymers (but these materials may not be as stable as the previous examples); glasses and ceramics (but these material may be more sensitive to bending, more bending can lead to cracks). The selection of material will depend on its strength and the temperature environment during manufacture and during operation (e.g., thermal expansion at various temperatures).

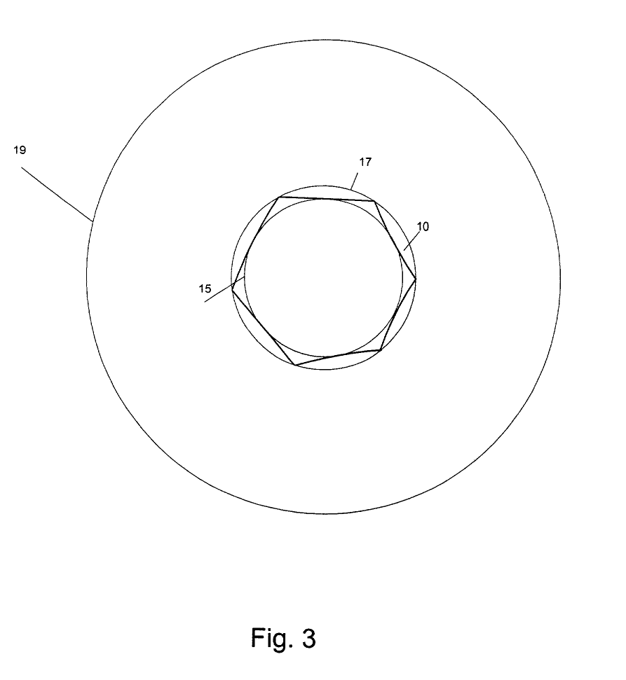

Referring to FIG. 3, a lens 15 is shown secured into the receptacle hole 17 of a washer 19 using the spring ring of FIGS. 1 and 2. The lens 15 is placed within the bent sections of the spring ring and the spring ring is further inserted into the receptacle hole 17 of the washer. As with the spring ring, the washer 19 may be made of a variety of suitable materials such as the aforementioned KOVAR alloy, stainless steel, molybdenum, etc. Preferably, the length of the spring ring 10 is selected so that in its bent position around the cylindrical lens, the ends of the spring ring do not touch. When the spring ring and lens are placed into the receptacle hole, the spring ring and hole should have, in effect, an interference fit such that the comers of the spring ring contact the inside surface of the receptacle and the sections of the spring ring deform (or at least exert pressure) in a direction towards the cylindrical surface of the lens. The pressure exerted on the cylindrical surface of the lens serves to hold the lens in place in the washer 19.

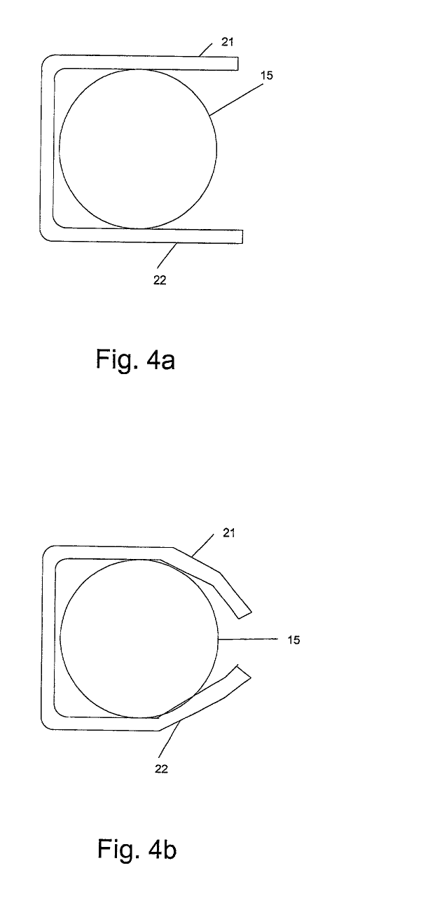

A second embodiment of the spring ring is shown in FIGS. 4a-b. In this embodiment, the spring ring 21 has three sections, and, when appropriately bent, the spring ring will have an approximately triangular shape. In this embodiment, the thickness of the spring ring 21 is, for example, 0.003 inches and the length of one of the legs 22 of the spring ring 21 is, for example, 0.046 inches. The spring ring may be bent into the configuration shown in FIG. 4b by hand and then crimped around the lens after it is inserted within the spring ring 21. The resulting structure is then inserted into the receptacle hole. As seen from the above examples, the spring ring can have a variety of configurations. Preferably, the spring ring has three or more sections that may be straight or arched that press upon the cylindrical item (e.g., the lens), when the two components are inserted into a receptacle hole. Examples of systems for this insertion procedure are presented below.

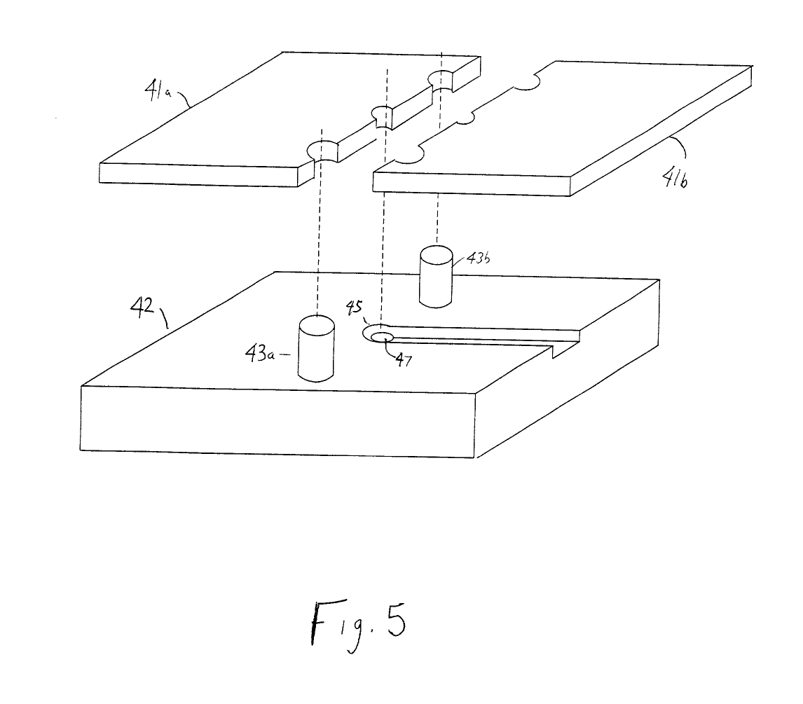

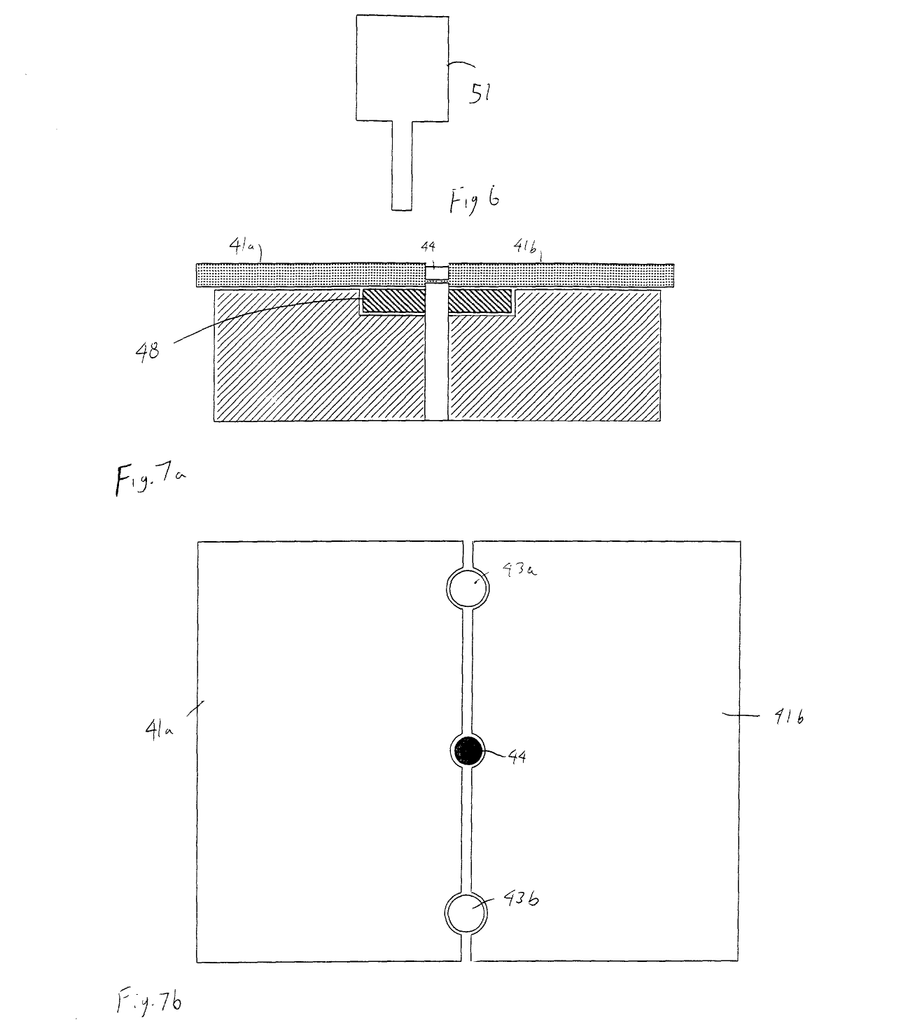

In a first embodiment of a system for inserting the lens and spring ring into the receptacle hole, the lens is placed within the spring ring and placed over the receptacle hole of the washer, a ramming tool is then used to press the spring ring and the lens into the receptacle hole. The height of the spring ring may be greater than that of the lens allowing the ramming tool to press on a surface of the spring ring without contacting (and potentially damaging) the lens. Referring to FIG. 5, first and second jaws 41a and 41b are provided for gripping the spring ring and lens (not shown specifically in FIG. 5). A base block 42 is also provided including guide pins 43a and 43b as well as slot 45 for receiving the washer (which includes a receptacle hole for the spring ring and lens as described above). Centered in the end portion of the slot is a relief hole 47 that holds a sliding support pin (not shown specifically in FIG. 5). In operation, a washer is moved over slot 45 to the slot's end. At this point the sliding support pin will be in its uppermost position to support the spring ring and lens. First and second jaws 41 a-b then move towards each other to clasp the guiding pins 43a-b as well as the spring ring and lens. A separate ramming tool 51 (see FIG. 6) is used to press the spring ring and lens into the receptacle hole of the washer. The sliding support pin moves downward into its relief hole 47. As stated above, the ramming tool 51 with its flat surface presses on the spring ring and not the lens when the spring ring has a height larger than that of the lens. Referring to FIGS. 7a-b, a cross section and top view of the manufacturing system of FIG. 5 are shown. As seen in these figures, the first and second jaws 41a-b press on and crimp the spring ring onto the lens (shown together as element 44) while these components rest on sliding support pin 46 through washer 48. The crimping operation decreases the diameter of the spring ring and lens combination so that it can be pressed into the receptacle hole of washer 48.

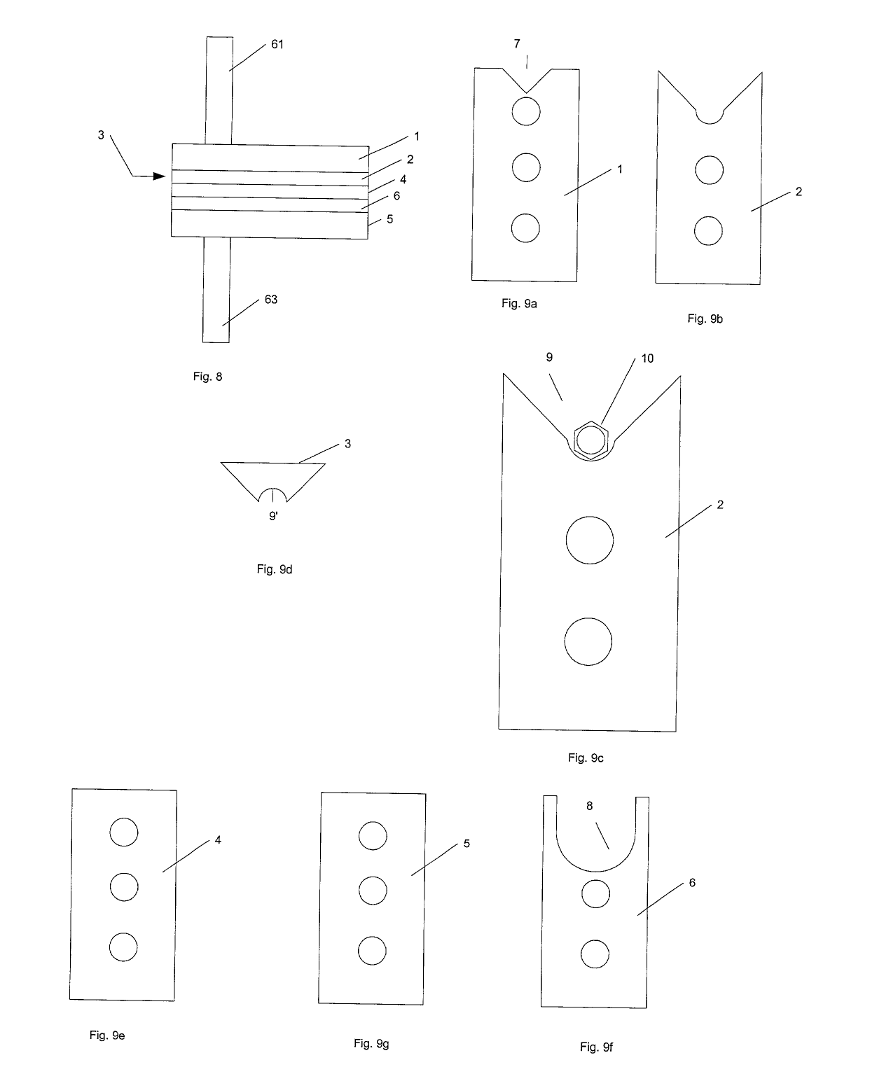

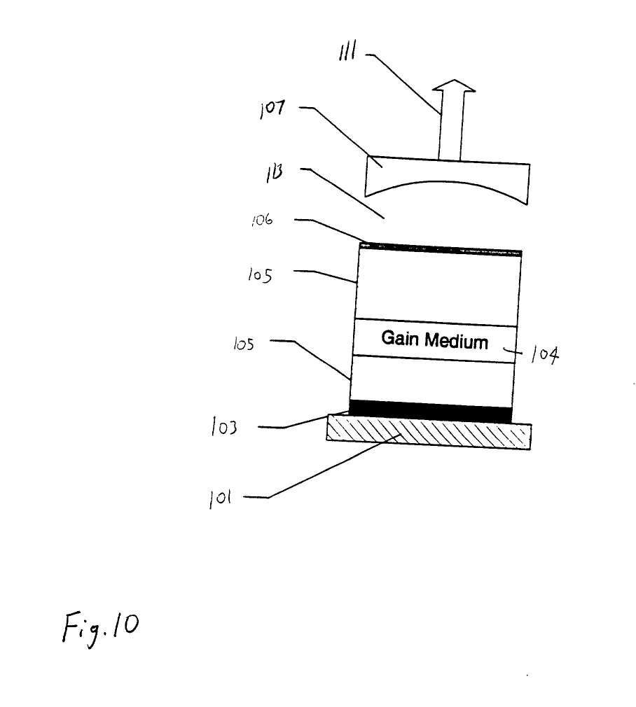

A second embodiment for a manufacturing system to insert the spring ring and lens into the receptacle hole of a washer is shown in FIG. 8. In this embodiment, the spring ring and lens are placed in a slot 7 of a first piece 1. The spring ring and lens are then moved into a lower holding piece 2 which may be designed so that the spring ring may only fit into it in one configuration (see below with reference to FIG. 9c). An upper holding piece 3 may then be placed on top of the lower holding piece 2 to crimp the spring ring around the lens. The spring ring and lens are then pushed through a hole in a second piece 4 and into the receptacle hole of the washer (not shown) inserted in slot 8 of slot piece 6. Third piece 5 provides lateral support for slot piece 6.

Referring to FIG. 9a, a schematic view of first piece 1 is shown. As seen in FIG. 9a, first piece 1 includes slot 7 for receipt of the spring ring and lens. For example, the lens and previously bent spring ring may be provided on a so-called “gel pack,” removed with tweezers grasping the spring ring and lens and placed in the slot of first piece 1. Guide holes may be provided in pieces 1 and 3-6 to facilitate guiding pins that keep proper alignment of these pieces.

Referring to FIG. 9b, a schematic of the lower holding piece 2 is shown. Lower holding piece 2 includes a receptacle 9 for receiving the spring ring and lens. FIG. 9c shows a closer view of the lower holding piece 2 with the spring ring 10 of FIG. 2. Because of its dimensions in this embodiment, the spring ring 10 will fit into receptacle 9 in only one orientation. Referring to FIG. 9d, upper holding piece 3 is shown which includes a receptacle 9′ that presses the spring ring 10 around the lens. Referring to FIG. 9e, second piece 4 is shown in more detail. In FIG. 9f, slot piece 6 is shown in more detail. As stated above, slot piece 6 includes slot 8 for insertion of the washer in which the spring ring and lens will be fitted. FIG. 9g shows third piece 5, which provides lateral support for slot piece 6 and the washer during insertion of the spring ring and lens. Referring back to FIG. 8, after the spring ring and lens are pressed using the lower and upper holding pieces 2 and 3 into receptacle 9, a ramming tool 61 (see FIG. 8) may be used to press the spring ring and lens into the washer held in slot 8. If desired a pin tool 63 (see FIG. 8) may be provided that is first inserted into the receptacle hole of the washer and then moved out as the spring ring and lens are moved in.

Referring to FIG. 10, an example of a semiconductor laser device that can utilize the washer/spring ring/lens combination described above is shown. In this example the laser device is a vertical extended cavity surface emitting laser device with an external lens/mirror. The laser device includes a substrate 101 upon which a bottom mirror 103 is placed or deposited. A gain medium 104 is placed or deposited on top of the bottom mirror 103. If desired, transparent spacers 105 may be placed on either side of the gain medium 104. In this embodiment, an optical component 107 is first inserted into a washer (not shown in FIG. 10) as described above. Also, in this embodiment, there is air 113 between the optical component 107 and the spacer 105. Furthermore, the spacer may include an anti-reflective coating 106. The side of the optical component facing the gain medium 104 is at least partially reflective and facilitates reflection of photons between the optical component and lower mirror 103. Those photons passing though optical component 107 are emitted as a laser light beam (indicated generally as element 111). Thus, in this embodiment, the optical component 107 serves as a mirror and as a lens.

Although embodiments are specifically illustrated and described herein, it is to be appreciated that modifications and variations of the present invention are covered by the above teachings and are within the purview of the appended claims, without departing from the spirit and intended scope of the invention. For example, though a lens that is at least partially cylindrical has been described above, the invention may be expanded to lenses of other shapes (e.g., the spring ring will work to hold a lens having a spherical shape in a receptacle hole). Although an embodiment is described using a laser as a light source, it is to be understood that the light source could be an LED or other known light source within the scope of the invention. Although the term “lens” is used throughout the description, the term “lens” includes optical components that serve as a mirror and/or a lens.

What is claimed is:

1. An apparatus for holding an optical component comprising:
a spring ring including a plurality of sections, said sections adapted to be angled relative to each other so as to hold said optical component.

2. The apparatus of claim 1 further comprising:
a holding device including a receptacle hole to receive said spring ring and optical component.

3. The apparatus of claim 2 wherein said optical component is a lens.

4. The apparatus of claim 3 wherein said holding device is a washer.

5. The apparatus of claim 3 wherein said spring ring has six sections.

6. The apparatus of claim 3 wherein said spring ring has three sections.

7. An apparatus for holding a lens comprising:
a spring ring including a plurality of sections, said sections adapted to be angled relative to each other so as to hold said lens.

8. The apparatus of claim 7 further comprising:
a washer including a receptacle hole to receive said spring ring and said lens.

9. The apparatus of claim 8 wherein said lens is cylindrical in shape.

10. The apparatus of claim 8 wherein said lens is spherical in shape.

11. A method of securing an optical component comprising:
positioning an optical component within a spring ring;
pressing said spring ring and optical component into a receptacle hole, wherein an interaction between said spring ring and receptacle hole work to secure said optical component in place.

12. The method of claim 11 wherein said receptacle hole is part of a holding device.

13. The method of claim 12 wherein said optical component is a lens.

14. The method of claim 13 wherein said holding device is a washer.

15. The method of claim 13 wherein said spring ring has six sections.

16. The method of claim 13 wherein said spring ring has three sections.

17. A photonic system comprising:
a light source;
a spring ring;
an optical component placed in said spring ring;
a washer including a receptacle hole to hold said spring ring and said optical component, wherein an interaction between said spring ring and receptacle hole work to secure said optical component in place.
